(19) United States
(12) Patent Application Publication
(10) Pub. No.: US 2022/0398354 A1
(43) Pub. Date: Dec. 15, 2022

(54) MODELING METHOD FOR INTEGRATED INTAKE/EXHAUST/ENGINE AERO PROPULSION SYSTEM WITH MULTIPLE GEOMETRIC PARAMETERS ADJUSTABLE

(71) Applicant: DALIAN UNIVERSITY OF TECHNOLOGY, Dalian, Liaoning (CN)

(72) Inventors: Ximing SUN, Dalian, Liaoning (CN); Chen WANG, Dalian, Liaoning (CN); Lu AI, Dalian, Liaoning (CN); Xian DU, Dalian, Liaoning (CN)

(21) Appl. No.: 17/625,283

(22) PCT Filed: Dec. 17, 2020
(86) PCT No.: PCT/CN2020/137143

§ 371 Date: Jan. 6, 2022

(51) Int. Cl. G06F 30/15

(52) U.S. Cl. CPC G06F 30/15; G06F 2111/10

(57) ABSTRACT

A modeling method for an integrated intake/exhaust/engine aero propulsion system with multiple geometric parameters adjustable includes the following steps: establishing an inlet and nozzle model by quasi one-dimensional aerodynamic thermodynamics and the method for solving the excitation system on the basis of a traditional engine component-level model; adding an inlet and engine flow balance equation and an engine and nozzle flow balance equation to the engine model, and establishing a propulsion system model based on the iteration method; and integrating the design of geometric parameters of an inlet and a nozzle into the model to realize the design of structure sizes of an intake/exhaust system and the simultaneous adjustment of multiple parameters.

### TECHNICAL FIELD

The present invention belongs to the field of numerical calculations of supersonic vehicles, comprises building of quasi one-dimensional aerodynamic thermodynamic models in intake/exhaust systems, establishment of aero-engine component-level models, design of variable geometry structures of inlets and nozzles, and building of integrated intake/exhaust/engine computing platforms of supersonic vehicles, and is the research on the intake/exhaust/engine coupling non-linear modeling method.

### BACKGROUND

With the innovation of modern supersonic vehicle technologies, the demand for propulsion system performance is also increasing. In the supersonic state, the matching coupling performance of components of a propulsion system has a strong impact on propulsion efficiency and reliability, and the matching quality of main accessories (such as inlet and nozzle) thereof determines the joint working efficiency of components. Researches show that the installation thrust loss is generally 10%45% for supersonic operation of an aero propulsion system, and the performance loss can reach 25%-30% in the acceleration/climb phase. From the view of installation performance, the installation thrust can be significantly improved by adjusting the geometric parameters of accessories to improve the matching characteristics of an intake/exhaust system and an engine. Therefore, it is of great significance and value to study the integration of intake/exhaust/engine of supersonic vehicles.

An aero-engine is a multivariable, nonlinear, time-varying complex model, which generally adopts a component-level non-linear aerodynamic thermodynamic model. The main concern of traditional models is the performance of aero-engines, main accessories (inlet and nozzle) are modeled through calculation of an idealized model and an empirical formula, and the influence of inflow and outflow characteristics and throttling characteristics of inlets and flow characteristics and thrust characteristics of nozzles is ignored. As supersonic vehicles operate at high Mach numbers, traditional pitot inlets will produce direct shock waves, and the total pressure recovery coefficient decreases sharply with the increase of Mach numbers, affecting the performance of the propulsion system, so variable geometry external compression inlets and mixed-compression supersonic inlets are mostly used; and for supersonic nozzles, Rafael nozzles (convergent-divergent nozzles) are mostly used instead of traditional convergent nozzles to obtain higher thrust characteristics. In addition, the adjustable geometric parameters of supersonic inlets and convergent-divergent nozzles are significantly increased, which provides potential for further improving the matching performance of the integrated intake/exhaust/engine propulsion system model. Therefore, the traditional modeling methods for inlets and nozzles cannot meet the requirements of calculation accuracy and fidelity of supersonic vehicles, so it is of important theoretical research and engineering application value to study the modeling methods for main accessories (inlet and nozzle) of integrated intake/exhaust/engine propulsion systems and realize adjustment of multiple geometric parameters.

At present, scholars from home and abroad have done some work on research on the modeling and matching performance of supersonic inlets. In terms of research on inlet calculation models, Mattingly mainly studies the design method for supersonic external compression inlets, and provides the basic calculation model of the total pressure recovery coefficient and the flow coefficient; Seddon studies the inlet drag, which provides the theoretical basis for calculation; Liu Pengchao, Zhang Xiaobo, Qianfei et al. model an inlet by the characteristic interpolation method, convert the inlet characteristic diagram published in the NASA report and realize calculation of the installation performance of inlet/engine coupling modeling, but the method has the problems of poor model convergence and real-time performance and dependence of accuracy on characteristic curves. In terms of inlet matching performance and variable geometry adjustment, geometric adjustment methods comprise air bleed adjustment, fine ramp angle adjustment, lip adjustment and boundary layer suction technologies, and diagrams of basic flow characteristics and throttling characteristics of different geometric structures are obtained by CFD simulation; Sun Fengyong et al. establish an integrated inlet/engine simulation model by using the inlet characteristic curve published in literature, and then realize design of variable geometry inlets through the characteristic diagram conversion method, but the problems of a large amount of calculation and poor accuracy of variable geometry characteristics of the model exist. Jia Linyuan models a supersonic inlet by the method for solving the excitation system, which has the advantage that the rapid calculation of installation performance can be realized, but the realization method for adjustment of multiple geometric parameters is not studied in depth. It can be seen from the above researches that in the integrated design of supersonic vehicles, it is necessary to establish a more accurate inlet/nozzle performance calculation model and ensure the real-time performance and reliability of calculation of the calculation model at the same time.

### SUMMARY

The traditional component-level model has the limitations of poor calculation accuracy and inability to predict installation performance in supersonic conditions, and the intake/exhaust system model established based on CFD or the characteristic interpolation method has the problems of poor real-time performance and low convergence speed in dynamic system calculation. In view of the problems, the present invention improves the fidelity and simulation accuracy of the propulsion system model by modeling an inlet and a nozzle through a quasi one-dimensional aerodynamic thermodynamic model in comprehensive consideration of characteristics of an intake/exhaust system on the basis of a traditional engine component-level model. In addition, the present invention integrates the idea of the adjustable design of the geometric structure of the inlet and the nozzle into the component-level model, which realizes adjustment of multiple geometric parameters of supersonic inlets and convergent-divergent nozzles, greatly improves the scope of application of the engine model and has stronger engineering application value.

The present invention has the basic idea that first, an inlet and nozzle model is established by quasi one-dimensional aerodynamic thermodynamics and the method for solving the excitation system in consideration of the shock structure and the drag calculation method of the inlet and the flow coefficient and the thrust coefficient of the nozzle on the basis of a traditional engine component-level model; then, an inlet and engine flow balance equation and an engine and nozzle flow balance equation are added to the engine model, and a propulsion system model is established based on the iteration method; and finally, the design of geometric parameters of the inlet and the nozzle is integrated into the model to realize the design of structure sizes of an intake/exhaust system and the simultaneous adjustment of multiple parameters.

The technical solution of the present invention is as follows:

A modeling method for an integrated intake/exhaust/engine aero propulsion system with multiple geometric parameters adjustable, comprises the following steps:

First, establishing an inlet and nozzle model by quasi one-dimensional aerodynamic thermodynamics and the method for solving the excitation system in further consideration of the influence of the shock structure and the drag of the inlet on the engine performance as well as the changing rule of the flow coefficient and the thrust coefficient of the nozzle under different working conditions on the basis of a traditional engine component-level model; then, adding an inlet and engine flow balance equation and an engine and nozzle flow balance equation to the engine model, and establishing a propulsion system model based on the iteration method; and finally, integrating the design of geometric parameters of an inlet and a nozzle into the engine model to realize the design of structure sizes of an intake/exhaust system and the simultaneous adjustment of multiple parameters;

The specific steps are as follows:

S1: building of quasi one-dimensional aerodynamic thermodynamic model in intake/exhaust system

S1.1: according to the actual engine structure, determining the basic types of an inlet and a nozzle, the inlet of a supersonic vehicle is generally an external compression inlet or a mixed-compression supersonic inlet, and the nozzle is generally a convergent nozzle or a convergent-divergent nozzle;

S1.2: determining the structure parameters and the design operating points of the inlet, and establishing the corresponding relationship between the structure parameters of the inlet and the design parameters of the actual engine critical state through the two-dimensional plane geometry relationship; and determining the structure size parameters of a convergent-divergent nozzle based on the actual engine structure;

S1.3: determining a designed shock system structure, and assuming that the inlet conditions (angle of attack, Mach number and flight altitude) are known, solving the total pressure recovery coefficient and the flow coefficient of the inlet under different inlet conditions by the method for solving the excitation system; and when the wavefront Mach number Ma_{f}, the adiabatic exponent of gas k and the ramp angle δ are known, solving the shock wave angle β by iteration according to formula (1), and determining the total pressure loss coefficient σ and the wave rear Mach number Ma_{b} of the shock wave according to formula (2) and formula (3):

$$tan δ = \frac{{Ma}_{f}^{2} {sin}^{2} β - 1}{[ {Ma}_{f}^{2} ( \frac{k + 1}{2} - {sin}^{2} β ) + 1 ] tan β} \qquad ( 1 )$$

$$σ = \frac{{[ \frac{( k + 1 ) {Ma}_{f}^{2} {sin}^{2} β}{2 + ( k - 1 ) {Ma}_{f}^{2} {sin}^{2} β} ]}^{\frac{k}{k - 1}}}{{[ \frac{2 k}{k + 1} {Ma}_{f}^{2} {sin}^{2} β - \frac{k - 1}{k + 1} ]}^{\frac{1}{k - 1}}} \qquad ( 2 )$$

$${Ma}_{b}^{2} = \frac{{Ma}_{f}^{2} + \frac{2}{k - 1}}{\frac{2 k}{k - 1} {Ma}_{f}^{2} {sin}^{2} β - 1} + \frac{{Ma}_{f}^{2} {cos}^{2} β}{\frac{k - 1}{2} {Ma}_{f}^{2} {sin}^{2} β + 1} \qquad ( 3 )$$

S1.4: establishing the calculation formula of the subsonic drag of the engine model; the drag D_{add} under the subsonic condition is mainly composed of additional drag, calculated through the loss of momentum of the airflow before the inlet lip in the horizontal direction, and expressed by formula (4): wherein Tₜₕ, Maₜₕ, Aₜₕ and W_{a, th} represent the throat temperature, the throat Mach number, the throat area and the throat flow, δ₀ represents the total turning angle of the inlet, Ma₀ represents the inlet Mach number of the inlet, A₀ represents the inlet free flow tube area, and k represents the adiabatic exponent of gas;

$${D}_{add} = \frac{{W}_{a , th}}{{kMa}_{0}} [ \frac{{Ma}_{0}}{{Ma}_{th}} \sqrt{\frac{{T}_{th}}{{T}_{0}}} ( 1 + {kMa}_{th}^{2} ) \cdot cos {δ}_{0} - ( \frac{{A}_{th}}{{A}_{0}} \cdot cos {δ}_{0} + {kMa}_{0}^{2} ) ] \qquad ( 4 )$$

S1.5: establishing the calculation formula of the supersonic drag of the engine model; under the supersonic condition, the external drag of the inlet comprises additional drag and overflow drag; when the flow coefficient of the inlet is greater than or equal to the maximum flow coefficient, the operation is under the critical or supercritical condition, and the overflow drag is 0; when the flow coefficient of the inlet is less than the maximum flow coefficient, the operation is under the subcritical condition, the shock wave does not seal the inlet, and the overflow drag appears; and the calculation formula of the supersonic drag D_{add} is expressed by formula (5), wherein Hₑ₁, Hₑ₂ and Hₑ₃ respectively represent vertical section heights of drag between shock waves of the inlet, Pₛ₁, Pₛ₂ and Pₛ₃ represent static pressures after shock waves, and Pₛ₀ represents the inlet total pressure of the inlet;

D_{add}=(Pₛ₁−Pₛ₀)Hₑ₁+(Pₛ₂−Pₛ₀)Hₑ₂+(Pₛ₃−Pₛ₀)H₃ (5)

S1.6: determining the basic type and adjustable variables of the nozzle, calculating the critical expansion ratio of the nozzle through structure parameters, and judging the operating state of the nozzle according to the total turbine outlet pressure and the environmental pressure: subcritical, critical and supercritical; and calculating the critical expansion ratio π_{Z,cr} of the nozzle according to formula (6), where Δ_{μk} represents the flow coefficient component of the conical nozzle, which is related to the convergent half angle α and the length L_{c} of the convergent section of the nozzle, and β is the divergent half angle;

$${π}_{NZ , cr} = 1 + \frac{{( \frac{k + 1}{2} )}^{\frac{k}{k - 1}} - 1 + 29 {Δ}_{μ k}}{1 + 0.088 \frac{\sqrt{\overline{{A}_{9}} - 1}}{0.005 + {β}^{1.5}}} , \overline{{A}_{9}} = \frac{{A}_{9}}{{A}_{8}} \qquad ( 6 )$$

S1.7: when the convergent-divergent nozzle is in the supercritical state, the area ratio

$$\frac{{A}_{9}}{{A}_{8}}$$

has an impact on the exit Mach number, wherein A₉ represents the exit area of the nozzle, and A₈ represents the throat area of the nozzle, obtaining the exit Mach number Ma₉ₜ by iterative solution according to formula (7);

$$( \frac{{A}_{9}}{{A}_{8}} ) = {\frac{1}{{Ma}_{9 t}} [ ( \frac{2}{K + 1} ) ( 1 + \frac{K - 1}{2} {Ma}_{9 t}^{2} ) ]}^{\frac{( K + 1 )}{[ 2 ( K - 1 ) ]}} \qquad ( 7 )$$

S1.8: calculating three characteristic flow state points of the convergent-divergent nozzle, determining the flow state in the nozzle according to the back pressure condition, and then calculating parameters such as exit total pressure, static pressure, total temperature and flow rate of the nozzle;

S1.9: calculating the flow coefficient ϕ_{N} and the thrust coefficient C_{F} of the convergent-divergent nozzle according to the known parameters by means of an engineering empirical formula, which are used for calculating the actual throat flow and the actual thrust; formula (8) is the calculation method of the flow coefficient, wherein A₇ represents the inlet area of the nozzle, and α represents the convergent half angle of the nozzle; and formula (9) is the calculation method of the thrust coefficient, wherein J_{C} represents the impulse coefficient, J_{P}(λ₉) represents the computed impulse of the nozzle, and F_{N,id}(π_{N,us}) represents the ideal thrust of the nozzle;

$${Φ}_{N} = 1 - 0.0585 \frac{( 1 + 2.63 α ) α}{1 + {α}^{2}} [ 1 - {( \frac{{A}_{8}}{{A}_{7}} )}^{2} ] - 0.01 [ 1 - {e}^{( - 0.5 {α}^{2} )} ] \frac{{A}_{8}}{{A}_{7}} \qquad ( 8 )$$

$${C}_{F} = \frac{{Φ}_{N} {π}_{N , us} {J}_{C} {J}_{P} ( {λ}_{9} ) - \frac{{A}_{9}}{{A}_{7}}}{{Φ}_{N} {F}_{N , id} ( {π}_{N , us} )} \qquad ( 9 )$$

S2: establishment of component-level model of propulsion system

S2.1: acquiring the characteristic curve of critical components (fan, compressor, turbine, etc.) of the aero-engine model; and respectively establishing the input/output module of a single component according to the sequence of propulsion system components based on aerodynamic thermodynamics, comprising gas flow equations and heat equations;

S2.2: determining known input parameters of the model based on operating conditions and states of the model, determining the number and types of iteration variables through the common working equations, and conducting simulation calculation according to a gas process;

S3: design of variable geometric parameters of inlet and nozzle

S3.1: connecting the structure sizes (length, width and height) of the inlet as input fixed parameters to an input end, wherein the values are generally determined by the design sizes;

S3.2: connecting the rank angle, the bleed valve opening degree and the boundary layer suction opening degree of the inlet as variable parameters to the input end, wherein the parameters can be adjusted at any time in a dynamic process;

S3.3: connecting the inlet area, the length of the convergent section, the length of the divergent section, the convergent angle and the divergent angle of the nozzle as input fixed parameters to the input end;

S3.4: connecting the throat area and the exit area of the nozzle as variable parameters to the input end;

S4: building of integrated intake/exhaust/engine computing platform of supersonic vehicle

S4.1: designing the inlet/exhaust/engine coupling component-level modeling and the iterative algorithm of supersonic vehicles by C++ programming, encapsulating the model through a dynamic link library, and introducing into a simulink module to establish a simulation platform;

S4.2: the parameters of the input end of the platform comprise structure sizes and adjustable parameters of the inlet and the nozzle, adjustable parameters of the engine model and environmental operating conditions, establishing a simulation platform of a dynamic process.

The present invention has the beneficial effects that: the present invention proposes to establish a propulsion system model through a quasi one-dimensional calculation idea, which overcomes the problems of poor convergence of iteration and dependence on the accuracy of characteristic diagrams of the characteristic interpolation method so that the propulsion system model has better calculation convergence; compared with CFD three-dimensional simulation intake/exhaust models, the present invention has high quasi one-dimensional calculation efficiency and good real-time performance and maintains a certain calculation accuracy; and the adjustment of multiple geometric parameters overcomes the disadvantage that the traditional characteristic interpolation method is only applicable to a single structure, and significantly improves the suitability and range of application of the model.

### DESCRIPTION OF DRAWINGS

FIG. 1 is a schematic diagram of structure size parameters of a typical external compression inlet in a critical state.

FIG. 2 is a schematic diagram of structure size parameters of a typical convergent-divergent nozzle;

FIG. 3 is a flow chart of a characteristics calculation module of an inlet.

FIG. 4 is a schematic diagram of external drag calculation parameters of an inlet.

FIG. 5 is a flow chart of a calculation module of a convergent-divergent nozzle.

FIG. 6 is a flow chart of a component-level model of a typical propulsion system.

FIG. 7 shows the changing rule of the thrust performance of a propulsion system with a secondary rank angle δ₂.

FIG. 8 shows the changing rule of the thrust performance of a propulsion system with a throat area A₈.

FIG. 9 shows the changing rule of the thrust performance of a propulsion system with an exit area A₉.

### DETAILED DESCRIPTION

The embodiments of the present invention will be further described below in combination with the drawings and the technical solution.

S1: building of quasi one-dimensional aerodynamic thermodynamic model in intake/exhaust system

According to the actual engine structure, determining the types of an inlet and a nozzle, and determining design structure parameters of the inlet based on the critical operating state;

S1.1: determining the basic types of the inlet and the nozzle; in the embodiment, with a typical supersonic vehicle as an example, the inlet is an external compression inlet, and the nozzle is a convergent-divergent nozzle.

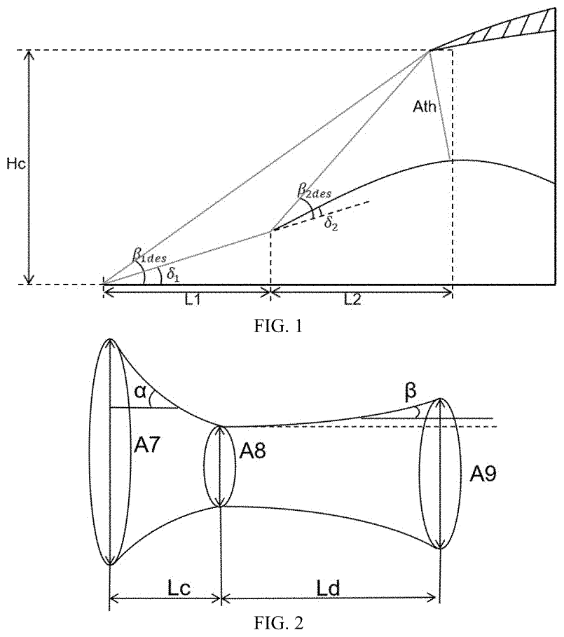

S1.2: determining the design operating points of the inlet. In the embodiment, an external compression inlet with two oblique and one direct shock waves is adopted, and the structure size parameters are determined through the two-dimensional plane geometry relationship to enable the shock waves to seal the inlet. The state is called a critical state, critical shock wave angles (β_{1des} and β_{des}) are determined by the structure size parameters, and the specific structure size parameters of the inlet are shown in FIG. 1. Assuming that the width of the inlet is S, and the lengths L₁ and L₂ and the height H_{c} are size parameters, the capture area is A_{c}=H_{c} S;

S1.3: based on the actual engine structure, determining the structure size parameters (inlet area, length of convergent section, length of divergent section, convergent angle and divergent angle) of the convergent-divergent nozzle, and determining the adjustable range of adjustable parameters including throat area A₈ and exit area A₉; FIG. 2 is a structural schematic diagram of a convergent-divergent nozzle.

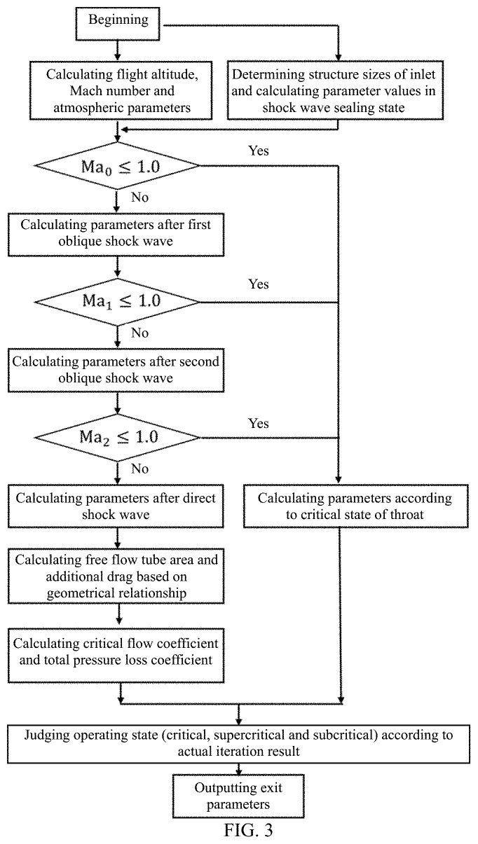

The present invention builds an inlet model based on the quasi one-dimensional calculation method, the basic calculation process of the inlet model is shown in FIG. 3, and the calculation thought is as follows:

S1.4: when the wavefront Mach number Ma_{f}, the adiabatic exponent of gas k and the ramp angle δ are known, solving the shock wave angle β by iteration according to formula 1, and determining the total pressure loss coefficient σ and the wave rear Mach number Ma_{b} of the shock wave according to formula 2 and formula 3. In the typical external compression inlet with two oblique and one direct shock waves, incoming flow passes through two oblique shock waves and one direct shock wave successively, and the above formulas are calculated for three times in sequence to obtain the shock wave angles β₁ and β₂ of the two oblique shock waves, the total pressure loss coefficients σ₁, σ₂ and σ₃ of the three shock waves, and Mach number Ma₃ after the direct shock wave; and the total pressure loss coefficient σᵢₙₗₑₜ of the inlet can be calculated according to formula 4 based on the above calculation results, and σ_{F} represents the total pressure loss of wall friction;

$$tan δ = \frac{{Ma}_{f}^{2} {sin}^{2} β - 1}{[ {Ma}_{f}^{2} ( \frac{k + 1}{2} - {sin}^{2} β ) + 1 ] tan β} \qquad ( 1 )$$

$$σ = \frac{{[ \frac{( k + 1 ) {Ma}_{f}^{2} {sin}^{2} β}{2 + ( k - 1 ) {Ma}_{f}^{2} {sin}^{2} β} ]}^{\frac{k}{k - 1}}}{{[ \frac{2 k}{k + 1} {Ma}_{f}^{2} {sin}^{2} β - \frac{k - 1}{k + 1} ]}^{\frac{1}{k - 1}}} \qquad ( 2 )$$

$${Ma}_{b}^{2} = \frac{{Ma}_{f}^{2} + \frac{2}{k - 1}}{\frac{2 k}{k - 1} {Ma}_{f}^{2} {sin}^{2} β - 1} + \frac{{Ma}_{f}^{2} {cos}^{2} β}{\frac{k - 1}{2} {Ma}_{f}^{2} {sin}^{2} β + 1} \qquad ( 3 )$$

$${σ}_{inlet} = {σ}_{F} \cdot {σ}_{1} \cdot {σ}_{2} … {σ}_{n} , wherein n is the number of shock waves \qquad ( 4 )$$

S1.5: the flow coefficient φᵢ of the inlet refers to the ratio of air mass flow Wₐᵢ into the inlet to air mass flow W_{ac} through the capture area, wherein A₀ represents the free flow tube area corresponding to inlet flow, A_{c} represents the capture area which is calculated according to the geometrical relationship, and the flow coefficient is calculated according to formula 5. Given the flight altitude and Mach number, φᵢ=φₘₐₓ is calculated through the geometrical relationship, and φₘₐₓ represents the maximum flow coefficient in this state; φᵢ<φₘₐₓ, in the subcritical state; and φᵢ>φₘₐₓ, in the supercritical state;

$${φ}_{i} = \frac{{W}_{ai}}{{W}_{a c}} = \frac{{ρ}_{0} {V}_{0} {A}_{0} \_ {A}_{0}}{{ρ}_{0} {V}_{0} {A}_{c} {A}_{c}} \qquad ( 5 )$$

S1.6: the drag of the supersonic inlet comprises external drag and external drag, wherein the internal drag (bleed drag and boundary layer suction drag) is determined by the opening degree of a bleed valve and a boundary layer suction valve, and the external drag is mainly composed of additional drag and overflow drag. The drag under the subsonic condition is mainly composed of additional drag D_{add}, which can be calculated through the loss of momentum of the airflow before the inlet lip in the horizontal direction, and expressed by formula 6. Tₜₕ, Maₜₕ, Aₜₕ and W_{a, th} represent the throat temperature, the Mach number, the area and the flow, δ represents the total turning angle of the inlet, Ma₀ represents the inlet Mach number of the inlet, A₀ represents the inlet free flow tube area, and k represents the adiabatic exponent of gas;

$${D}_{add} = \frac{{W}_{a , th}}{{kMa}_{0}} [ \frac{{Ma}_{0}}{{Ma}_{th}} \sqrt{\frac{{T}_{th}}{{T}_{0}}} ( 1 + {kMa}_{th}^{2} ) \cdot cos δ - ( \frac{{A}_{th}}{{A}_{0}} \cdot cos δ + {kMa}_{0}^{2} ) ] \qquad ( 6 )$$

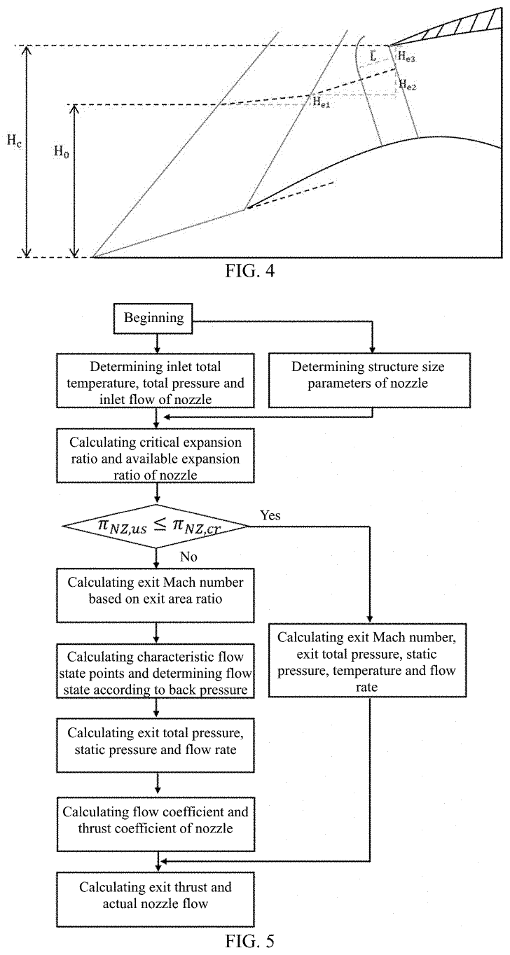

S1.7: under the supersonic condition, the external drag of the inlet comprises additional drag and overflow drag. when the flow coefficient of the inlet is greater than or equal to the maximum flow coefficient, the operation is under the critical or supercritical condition, and the overflow drag is 0; and when the flow coefficient of the inlet is less than the maximum flow coefficient, the operation is under the subcritical condition, the shock wave does not seal the inlet, and the overflow drag will appear. The supersonic drag D_{add} is calculated according to formula 7, and the parameters are shown in FIG. 4. The calculation result of the above formula is small in the subcritical state, and the drag correction coefficient ΔC_{add} can be calculated based on the Moeckel theory and expressed by formula 11, wherein Pₛ₁, Pₛ₂ and Pₛ₃ represent static pressures after shock waves, and L represents the distance of detachment of shock waves.

$${D}_{add} = ( {P}_{s 1} - {P}_{0} ) {H}_{e 1} + ( {P}_{s 2} - {P}_{0} ) {H}_{e 2} + ( {P}_{s 3} - {P}_{0} ) {H}_{e 3} \qquad ( 7 )$$

$${H}_{e 2} = {A}_{th} sin ( {δ}_{1} + {δ}_{2} ) ( \frac{1}{sin ( {β}_{2 des} - {δ}_{2} )} - \frac{1}{sin ( {β}_{2} - {δ}_{2} )} ) \qquad ( 8 )$$

$${H}_{e 3} = {A}_{th} sin ( {δ}_{1} + {δ}_{2} ) ( \frac{1}{sin ( {β}_{2 des} - {δ}_{2} )} - \frac{1}{sin ( {β}_{2} - {δ}_{2} )} ) \qquad ( 9 )$$

$${H}_{e 1} = {H}_{c} - {H}_{0} - {H}_{e 2} - {H}_{e 3} \qquad ( 10 )$$

$$Δ {C}_{add} = \frac{2}{{kMa}_{0}^{2}} [ \frac{1}{2} ( {P}_{s 2} + {P}_{s 3} ) - {P}_{s 1} ] \cdot \overline{L} \cdot sin ( {δ}_{1} + {δ}_{2} ) \qquad ( 11 )$$

The basic calculation process of the nozzle model is shown in FIG. 5, and the calculation thought is as follows:

S1.8: with the convergent-divergent nozzle as an example, calculating the critical expansion ratio π_{NZ,cr} of the nozzle according to formula 12, where Δ_{μk} represents the flow coefficient component of the conical nozzle, which is related to the convergent half angle α and the length of the convergent section L_{c} of the nozzle, and β is the divergent half angle. Calculating the available expansion ratio π_{NZ,us} according to formula 13 based on the total turbine outlet pressure and the environmental pressure, and judging the operating state (subcritical, critical and supercritical) of the nozzle; when π_{Nz,us}≤π_{NZ,cr}, the operation is in the subcritical or critical state; and π_{NZ,us}>π_{NZ,cr}, the operation is in the supercritical state.

$${π}_{NZ , cr} = 1 + \frac{{( \frac{k + 1}{2} )}^{\frac{k}{k - 1}} - 1 + 29 {Δ}_{μ k}}{1 + 0.088 \frac{\sqrt{\overline{{A}_{9}} - 1}}{0.005 + {β}^{1.5}}} , \overline{{A}_{9}} = \frac{{A}_{9}}{{A}_{8}} \qquad ( 12 )$$

$${π}_{NZ , us} = \frac{{P}_{7}}{{P}_{0}} \qquad ( 13 )$$

S1.9: when the convergent-divergent nozzle is in the subcritical state, the area ratio

$$\frac{{A}_{9}}{{A}_{8}}$$

has no impact on the exit flow state, and the exit Mach number is less than 1; when the convergent-divergent nozzle is in the supercritical state, the area ratio

$$\frac{{A}_{9}}{{A}_{8}}$$

has an impact on the exit Mach number, and the exit Mach number Ma₉ₜ is obtained by iterative solution according to formula 14 (when subsonic airflow appears at the exit, Ma_{sub}=Ma₉ₜ; and when supersonic airflow appears at the exit, Maₛᵤₚ=Ma₉ₜ).

$$( \frac{{A}_{9}}{{A}_{8}} ) = {\frac{1}{{Ma}_{9 t}} [ ( \frac{2}{κ + 1} ) ( 1 + \frac{κ - 1}{2} {Ma}_{9 t}^{2} ) ]}^{\frac{( κ + 1 )}{[ 2 ( κ - 1 ) ]}} \qquad ( 14 )$$

S1.10: after the area ratio of the convergent-divergent nozzle is given according to the designed expansion ratio, when the environmental back pressure changes, the nozzle will expand incompletely or excessively, forming different flow states, wherein three typical characteristic flow state points are respectively P₁, P₂ and P₃, P_{8c} represents the inlet total pressure of the nozzle, and the calculation formulas are as follows:

$${P}_{1} = {{P}_{8 c} ( 1 + \frac{k - 1}{2} {Ma}_{sup}^{2} )}^{\frac{k}{1 - k}} ( {Ma}_{sup} > 1 ) \qquad ( 15 )$$

$${P}_{3} = {{P}_{8 c} ( 1 + \frac{k - 1}{2} {Ma}_{s u b}^{2} )}^{\frac{k}{1 - k}} ( {Ma}_{s u b} < 1 ) \qquad ( 16 )$$

$${P}_{2} = {P}_{1} ( \frac{2 k}{k + 1} {Ma}_{i}^{2} - \frac{k - 1}{k + 1} ) ( {Ma}_{i} > 1 ) \qquad ( 17 )$$

S1.11: after the four flow conditions of the convergent-divergent nozzle are determined, determining the flow state in the nozzle according to the back pressure condition P_{b}, and then calculating parameters such as exit total pressure P₉, static pressure Pₛ₉ and exit flow rate V₉ of the nozzle.

$${P}_{s 9} = \{ \begin{matrix}{P}_{1} , & {P}_{0} < {P}_{2} \\ {P}_{0} , & {P}_{2} \leq {P}_{b}\end{matrix} \qquad ( 18 )$$

$${P}_{9} = \{ \begin{matrix}{P}_{8 c} , {P}_{0} < {P}_{2} or {P}_{0} > {P}_{3} \\ {{P}_{s 9} ( 1 + \frac{k - 1}{2} {Ma}_{sup}^{2} )}^{\frac{k}{k - 1}} , {P}_{2} < {P}_{0} < {P}_{3}\end{matrix} \qquad ( 19 )$$

$${V}_{9} = \sqrt{2 {C}_{p 9} {{T}_{o} ( 1 - \frac{{P}_{9}}{{P}_{s 9}} )}^{\frac{1 - k}{k}}} , {C}_{p 9} is the specific heat ratio \qquad ( 20 )$$

S1.12: in the actual flow process of the nozzle, the actual throat flow and the actual thrust cannot reach the ideal state. The present invention calculates the flow coefficient and the thrust coefficient of the nozzle according to the known parameters by means of an engineering empirical formula, which are used for calculating the actual throat flow and the actual thrust. Formula 21 is the calculation method of the flow coefficient, wherein A₇ represents the inlet area of the nozzle, and a represents the convergent half angle of the nozzle; and formula 22 is the calculation method of the thrust coefficient, wherein J_{c} represents the impulse coefficient, J_{P}(λ₉) represents the computed impulse of the nozzle, and F_{N,id}(π_{N,us}) represents the ideal thrust of the nozzle.

$${Φ}_{N} = 1 - 0.0585 \frac{( 1 + 2.63 α ) α}{1 + {α}^{2}} [ 1 - {( \frac{{A}_{8}}{{A}_{7}} )}^{2} ] - 0.01 [ 1 - {e}^{( - 0.5 {α}^{2} )} ] \frac{{A}_{8}}{{A}_{7}} \qquad ( 21 )$$

$${C}_{F} = \frac{{Φ}_{N} {π}_{N , us} {J}_{C} {J}_{P} ( {λ}_{9} ) - \frac{{A}_{9}}{{A}_{7}}}{{Φ}_{N} {F}_{N , id} ( {π}_{N , us} )} \qquad ( 22 )$$

S2: establishment of component-level model of propulsion system

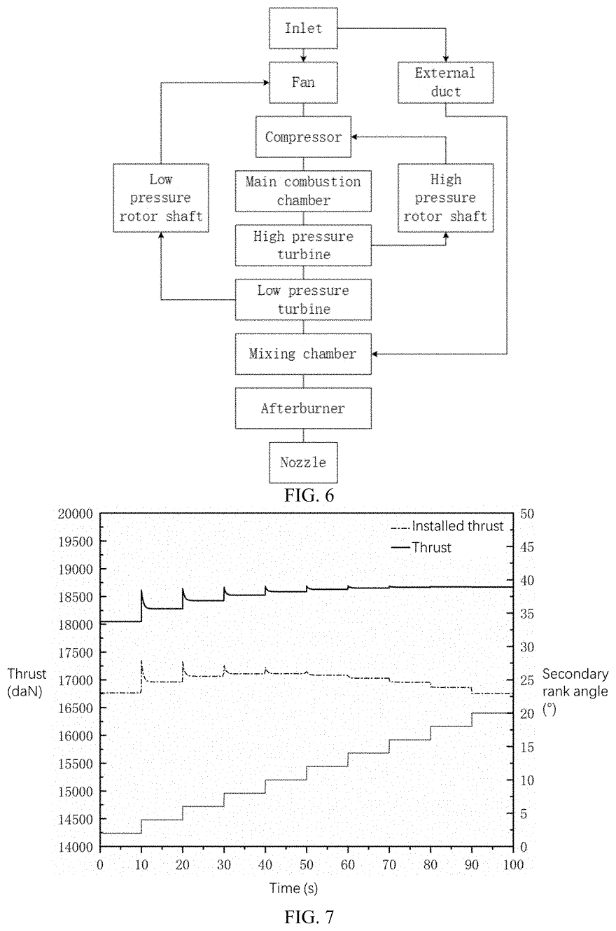

S2.1: FIG. 6 is a schematic diagram showing the composition of a component-level model of a typical propulsion system. Writing input/output modules of an inlet, a fan, a compressor, a combustion chamber, a high pressure turbine, a low pressure turbine, an external duct, a mixing chamber, an afterburner and a nozzle in C++ language based on gas flow and aerodynamic thermodynamic formulas.

S2.2: determining known input parameters of the model based on operating conditions and states of the model, determining the number and types of iteration variables through the common working equations, and conducting simulation calculation according to a gas process;

S2.3: the matching of the inlet, the nozzle and the engine needs to meet the flow and pressure balance, and when the engine is in a steady state or a dynamic operating state, flow, power and rotor dynamic equilibrium equations need to be satisfied simultaneously. The equilibrium equation residual of the propulsion system is represented by e. Selecting n iteration variables x based on the characteristics of the model, and conducting simultaneous solution on n common working equations:

$$\begin{matrix}\begin{matrix}\begin{matrix}{f}_{1} ( {x}_{0} , {x}_{1} , {x}_{2} … , {x}_{n} ) = {e}_{1} \\ {f}_{2} ( {x}_{0} , {x}_{1} , {x}_{2} … , {x}_{n} ) = {e}_{2}\end{matrix} \\ … …\end{matrix} \\ {f}_{n} ( {x}_{0} , {x}_{1} , {x}_{2} … , {x}_{n} ) = {e}_{n}\end{matrix}$$

S2.4: after the input parameters of the inlet and the nozzle and the external environment variables (Mach number, flight altitude, main fuel flow, afterburner fuel flow and nozzle exit area) are determined, the problem essentially becomes a non-linear implicit equation set with unknown independent variables, which is calculated by numerical iterative algorithms, and the model is considered to obtain a reliable solution when n residual values of the common working equation approach 0.

S3: determination of variable geometric parameters of inlet and nozzle

S3.1: connecting the structure sizes (length, width and height) of the inlet as input fixed parameters to an input end, wherein the input fixed geometric parameters of a typical external compression inlet with two oblique and one direct shock waves comprise: width S, lengths L₁ and L₂, and height H_{c} of the inlet, which are generally determined by the design sizes.

S3.2: connecting the rank angles δ₁ and δ₂, the bleed valve opening degree and the boundary layer suction opening degree of the inlet as variable parameters to the input end, wherein the parameters can be adjusted at any time in a dynamic process. The change of the rank angles will affect the geometrical relationship of the shock wave calculation of the inlet, and the mapping relationship between the bleed valve and the boundary layer suction is established according to the opening degree and the exhaust volume, which will affect the actual flow into the engine.

S3.3: connecting the inlet area A₇, the length L_{c} of the convergent section, the length L_{d} of the divergent section, the convergent half angle α and the divergent angle β of the nozzle as input fixed parameters to the input end;

S3.4: connecting the throat area A₈ and the exit area A₉ of the nozzle as variable parameters to the input end;

S4: building of integrated intake/exhaust/engine computing platform of supersonic vehicle

S4.1: designing the inlet/exhaust/engine coupling component-level modeling and the iterative algorithm of supersonic vehicles by C++ programming, encapsulating the model through a dynamic link library, and introducing into a simulink module to establish a simulation platform;

S4.2: the parameters of the input end of the platform comprise structure sizes and adjustable parameters of the inlet and the nozzle, adjustable parameters of the engine model and environmental operating conditions, establishing a simulation platform of a dynamic process.

S5: analysis of calculation result of inlet/exhaust/engine coupling modeling

S5.1: with the operation condition with the maximum flight altitude and Ma=1.2 as the design operating point of the inlet, adjusting the structure parameters (S, L₁, L₂ and H_{c}) of the inlet, wherein the throat area is obtained according to the maximum demand area to enable the shock waves to seal the inlet; and the structure parameters of the nozzle are determined according to the actual parameters.

S5.2: under the operation conditions of H=10 km, Ma=2, Wfa=0.9 kg/s, adjusting the secondary rank angle, and the changing rule of the thrust of the propulsion system and the installation thrust with the rank angle is shown in FIG. 7. It can be seen that with the increase of the rank angle, the thrust remains stable after a small increment, and the engine thrust remains basically unchanged when δ₂=12°, indicating that the rank adjustment has a limited influence on the performance of engine components. When the rank angle increases, the installation thrust increases first, then decreases and reaches the maximum value when δ₂=10°. Compared with the original state, the installation thrust is increased by 1.99%, indicating that the proper adjustment of the rank angle can significantly improve the installation thrust performance of the engine.

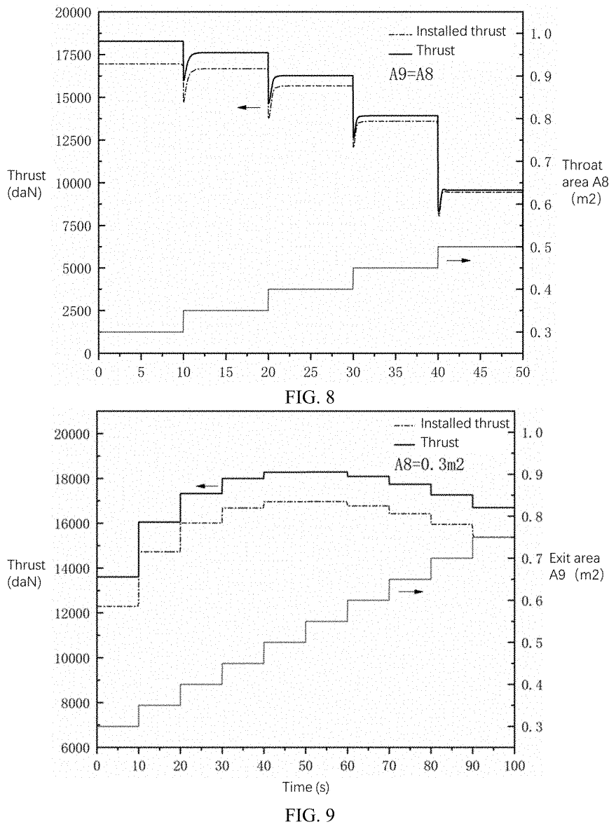

S5.3: under the operation conditions of H=10 km, Ma=2, Wfa=0.9 kg/s, the adjustment of the throat area A₈ and the exit area A₉ can significantly affect the flow state in the nozzle and the engine thrust. FIG. 8 shows the influence of the change of the throat area A₈ on the thrust, and FIG. 9 shows the influence of the exit area A₉ on the thrust. It can be seen that the throat area A₈ has a great influence on the operating points of the engine, the thrust significantly decreases with the increase of the area, the thrust and the installation thrust reach the maximum value when A₈=0.3 m², but the installation drag of the engine decreases, indicating that the adjustment of A₈ changes the state operating points of the engine and the flow demand, and reduces the overflow drag of the inlet; and under the condition of A₈=0.3 m², the adjustment of the exit area A₉ can effectively increase the thrust and the installation thrust, which has a great influence, and when A₉ increases to 0.55 from 0.3, the engine thrust is increased by 34%, and the installation thrust is increased by 38%. On the other hand, the adjustment of A₉ has a small influence on the installation drag, indicating that the adjustment of A₉ mainly affects the exit flow state of the nozzle, and has little influence on the engine operating points. Therefore, a fixed throat area A₈ and a fixed area ratio

$$( \frac{{A}_{9}}{{A}_{8}} )$$

exist to make the performance of the propulsion system optimal.

1. A modeling method for an integrated intake/exhaust/engine aero propulsion system with multiple geometric parameters adjustable, comprising the following steps:
first, establishing an inlet and nozzle model by quasi one-dimensional aerodynamic thermodynamics and the method for solving the excitation system in further consideration of the influence of the shock structure and the drag of the inlet on the engine performance as well as the changing rule of the flow coefficient and the thrust coefficient of the nozzle under different working conditions on the basis of a traditional engine component-level model; then, adding an inlet and engine flow balance equation and an engine and nozzle flow balance equation to the engine model, and establishing a propulsion system model based on the iteration method; and finally, integrating the design of geometric parameters of an inlet and a nozzle into the engine model to realize the design of structure sizes of an intake/exhaust system and the simultaneous adjustment of multiple parameters;
the specific steps are as follows:
S1: building of quasi one-dimensional aerodynamic thermodynamic model in intake/exhaust system
S1.1: according to the actual engine structure, determining the basic types of an inlet and a nozzle;
S1.2: determining the structure parameters and the design operating points of the inlet, and establishing the corresponding relationship between the structure parameters of the inlet and the design parameters of the actual engine critical state through the two-dimensional plane geometry relationship; and determining the structure size parameters of a convergent-divergent nozzle based on the actual engine structure;
S1.3: determining a designed shock system structure, and assuming that the inlet conditions are known, solving the total pressure recovery coefficient and the flow coefficient of the inlet under different inlet conditions by the method for solving the excitation system; and when the wavefront Mach number Ma_{f}, the adiabatic exponent of gas k and the ramp angle δ are known, solving the shock wave angle β by iteration according to formula (1), and determining the total pressure loss coefficient σ and the wave rear Mach number Ma_{b} of the shock wave according to formula (2) and formula (3):
$$tan δ = \frac{{Ma}_{f}^{2} {sin}^{2} β - 1}{[ {Ma}_{f}^{2} ( \frac{k + 1}{2} - {sin}^{2} β ) + 1 ] tan β} \qquad ( 1 )$$
$$σ = \frac{{[ \frac{( k + 1 ) {Ma}_{f}^{2} {sin}^{2} β}{2 + ( k - 1 ) {Ma}_{f}^{2} {sin}^{2} β} ]}^{\frac{k}{k - 1}}}{{[ \frac{2 k}{k + 1} {Ma}_{f}^{2} {sin}^{2} β \frac{k - 1}{k + 1} ]}^{\frac{1}{k - 1}}} \qquad ( 2 )$$
$${Ma}_{b}^{2} = \frac{{Ma}_{f}^{2} + \frac{2}{k - 1}}{\frac{2 k}{k - 1} {Ma}_{f}^{2} {sin}^{2} β - 1} + \frac{{Ma}_{f}^{2} {cos}^{2} β}{\frac{k - 1}{2} {Ma}_{f}^{2} {sin}^{2} β + 1} \qquad ( 3 )$$
S1.4: establishing the calculation formula of the subsonic drag of the engine model; the drag D_{add} under the subsonic condition is mainly composed of additional drag, calculated through the loss of momentum of the airflow before the inlet lip in the horizontal direction, and expressed by formula (4): wherein Tₜₕ, Maₜₕ, Aₜₕ and W_{a, th} represent the throat temperature, the throat Mach number, the throat area and the throat flow, δ₀ represents the total turning angle of the inlet, Ma₀ represents the inlet Mach number of the inlet, A₀ represents the inlet free flow tube area, and k represents the adiabatic exponent of gas;
$${D}_{add} = \frac{{W}_{a , th}}{{kMa}_{0}} [ \frac{{Ma}_{0}}{{Ma}_{th}} \sqrt{\frac{{T}_{th}}{{T}_{0}}} ( 1 + {kMa}_{t h}^{2} ) \cdot cos {δ}_{0} - ( \frac{{A}_{th}}{{A}_{0}} \cdot cos {δ}_{0} + {kMa}_{0}^{2} ) ] \qquad ( 4 )$$
S1.5: establishing the calculation formula of the supersonic drag of the engine model; under the supersonic condition, the external drag of the inlet comprises additional drag and overflow drag; when the flow coefficient of the inlet is greater than or equal to the maximum flow coefficient, the operation is under the critical or supercritical condition, and the overflow drag is 0; when the flow coefficient of the inlet is less than the maximum flow coefficient, the operation is under the subcritical condition, the shock wave does not seal the inlet, and the overflow drag appears; and the calculation formula of the supersonic drag D_{add} is expressed by formula (5), wherein Hₑ₁, Hₑ₂ and Hₑ₃ respectively represent vertical section heights of drag between shock waves of the inlet, Pₛ₁, Pₛ₂ and Pₛ₃ represent static pressures after shock waves, and Pₛ₀ represents the inlet total pressure of the inlet;
D_{add}=(Pₛ₁−Pₛ₀)Hₑ₁+(Pₛ₂−Pₛ₀)Hₑ₂+(Pₛ₃−Pₛ₀)Hₑ₃ (5)
S1.6: determining the basic type and adjustable variables of the nozzle, calculating the critical expansion ratio of the nozzle through structure parameters, and judging the operating state of the nozzle according to the total turbine outlet pressure and the environmental pressure: subcritical, critical and supercritical; and calculating the critical expansion ratio π_{NZ,cr} of the nozzle according to formula (6), where Δ_{μk} represents the flow coefficient component of the conical nozzle, which is related to the convergent half angle α and the length L_{c} of the convergent section of the nozzle, and β is the divergent half angle;
$${π}_{NZ , cr} = 1 + \frac{{( \frac{k + 1}{2} )}^{\frac{k}{k - 1}} - 1 + 29 {Δ}_{μ k}}{1 + 0.088 \frac{\sqrt{\overline{{A}_{9}} - 1}}{0.005 + {β}^{1.5}}} , \overline{{A}_{9}} = \frac{{A}_{9}}{{A}_{8}} \qquad ( 6 )$$
S1.7: when the convergent-divergent nozzle is in the supercritical state, the area ratio of
$$\frac{{A}_{9}}{{A}_{8}}$$
has an impact on the exit Mach number, wherein A₉ represents the exit area of the nozzle, and A₈ represents the throat area of the nozzle, obtaining the exit Mach number Ma₉ₜ by iterative solution according to formula (7);
$$( \frac{{A}_{9}}{{A}_{8}} ) = {\frac{1}{{Ma}_{9 t}} [ ( \frac{2}{κ + 1} ) ( 1 + \frac{κ - 1}{2} {Ma}_{9 t}^{2} ) ]}^{\frac{( κ + 1 )}{[ 2 ( κ - 1 ) ]}} \qquad ( 7 )$$
S1.8: calculating three characteristic flow state points of the convergent-divergent nozzle, determining the flow state in the nozzle according to the back pressure condition, and then calculating the exit total pressure, the static pressure, the total temperature and the flow rate of the nozzle;
S1.9: calculating the flow coefficient Φ_{N} and the thrust coefficient C_{F} of the convergent-divergent nozzle according to the known parameters by means of an engineering empirical formula, which are used for calculating the actual throat flow and the actual thrust; formula (8) is the calculation method of the flow coefficient, wherein A₇ represents the inlet area of the nozzle, and α represents the convergent half angle of the nozzle; and formula (9) is the calculation method of the thrust coefficient, wherein J_{c} represents the impulse coefficient, J_{P}(λ₉) represents the computed impulse of the nozzle, and F_{N,id}(π_{N,us}) represents the ideal thrust of the nozzle;
$${Φ}_{N} = 1 - 0.0585 \frac{( 1 + 2.63 α ) α}{1 + {α}^{2}} [ 1 - {( \frac{{A}_{8}}{{A}_{7}} )}^{2} ] - 0.01 [ 1 - {e}^{( - 0.5 {α}^{2} )} ] \frac{{A}_{8}}{{A}_{7}} \qquad ( 8 )$$
$${C}_{F} = \frac{{Φ}_{N} {π}_{N , us} {J}_{C} {J}_{P} ( {λ}_{9} ) - \frac{{A}_{9}}{{A}_{7}}}{{Φ}_{N} {F}_{N , id} ( {π}_{N , us} )} \qquad ( 9 )$$
S2: establishment of component-level model of propulsion system
S2.1: acquiring the characteristic curve of critical components of the aero-engine model; and respectively establishing the input/output module of a single component according to the sequence of propulsion system components based on aerodynamic thermodynamics, comprising gas flow equations and heat equations;
S2.2: determining known input parameters of the model based on operating conditions and states of the model, determining the number and types of iteration variables through the common working equations, and conducting simulation calculation according to a gas process;
S3: design of variable geometric parameters of inlet and nozzle
S3.1: connecting the structure sizes of the inlet as input fixed parameters to an input end, wherein the values are determined by the design sizes;
S3.2: connecting the rank angle, the bleed valve opening and the boundary layer suction opening of the inlet as variable parameters to the input end, wherein the parameters are adjusted at any time in a dynamic process;
S3.3: connecting the inlet area, the length of the convergent section, the length of the divergent section, the convergent angle and the divergent angle of the nozzle as input fixed parameters to the input end;
S3.4: connecting the throat area and the exit area of the nozzle as variable parameters to the input end;
S4: building of integrated intake/exhaust/engine computing platform of supersonic vehicle
S4.1: designing the inlet/exhaust/engine coupling component-level modeling and the iterative algorithm of supersonic vehicles by C++ programming, encapsulating the model through a dynamic link library, and introducing into a simulink module to establish a simulation platform;
S4.2: the parameters of the input end of the platform comprise structure sizes and adjustable parameters of the inlet and the nozzle, adjustable parameters of the engine model and environmental operating conditions, establishing a simulation platform of a dynamic process.
